(19) United States
(12) Patent Application Publication
(10) Pub. No.: US 2012/0168115 A1
(43) Pub. Date: Jul. 5, 2012

(54) INTEGRATION OF A SURFACE HEAT-EXCHANGER WITH REGULATED AIR FLOW IN AN AIRPLANE ENGINE

(75) Inventors: Nicolas Raimarckers, Tourinne (BE); Cédric Borbouse, Clavier (BE); Albert Cornet, Verviers (BE); Denis Bajusz, Remicourt (BE)

(73) Assignee: TECHSPACE AERO S.A., Milmort (BE)

(21) Appl. No.: 13/334,422

(22) Filed: Dec. 22, 2011

(30) Foreign Application Priority Data
Dec. 31, 2010 (EP) 10197456.6

(51) Int. Cl. B60H 1/32

(52) U.S. Cl. 165/41

(57) ABSTRACT

The present invention relates to a surface air-cooled oil cooler (1) in an airplane engine comprising at least one first oil circuit (4) and at least a first (2) and a second (3) exchange surface positioned on either side of the first oil circuit (4) and each able to be swept by an air flow, said second exchange surface (3) being positioned in the cavity (9) provided with an air inlet (6) and an air outlet (7), said inlet (6) and/or said outlet (7) comprising covering means (8) that allow to regulate the air supply on the second exchange surface (3).

### CROSS-REFERENCE TO RELATED PATENT APPLICATIONS

This patent application claims the benefit of European Patent Application No. 10197456.6, filed Dec. 31, 2010, the entire teachings and disclosure of which are incorporated herein by reference thereto.

### FIELD OF THE INVENTION

The present invention relates to a heat-exchanger in aeronautics. It more particularly relates to a surface heat-exchanger whose heat transfers can be modulated depending on the usage phases of the airplane on the ground and during flight, respectively.

It also relates to a surface heat-exchanger provided with means for deicing part of the airplane.

The present invention also relates to an airplane engine comprising such a heat-exchanger.

### STATE OF THE ART

In a turbomachine, different members and pieces of equipment (bearing enclosures, gearboxes, electrical machines, etc.) must be lubricated and/or cooled, the generated heat generally being transported by oil systems and evacuated by fuel-cooled oil and/or air-cooled oil coolers.

Current engines create a growing number of calories due to the increasing loading of the bearing enclosures, the integration of high-power gearboxes (turboprop, open rotor, etc.), and the integration of new pieces of equipment (high-power starter generator, etc.). As a result, the fuel-cooled oil coolers (FCOC) are saturated and require a supplement in the form of air-cooled oil coolers (ACOC).

Several types of air-cooled oil coolers exist. There are the brick-type exchangers. These are fairly heavy exchangers that have the drawback of disrupting the air flow and therefore penalizing the global output (increase in specific fuel consumption, SFC). In fact, for brick-type exchangers, the air is supplied by a system of ducts that cause increased drag or by a bleed system of the engine air flow that causes an aerodynamic disruption in the flow. Brick-type exchangers do, however, have the advantage that the air flow can be controlled with a rate generator (blower) and/or a rate limiter (flapper) depending on the usage phase of the airplane. This allows to limit the mass and the SFC (specific fuel consumption) impact of this technology, which is fundamentally heavy and intrusive in the flow, as the rate generator allows to decrease the size of the exchanger and the rate limiter decreases the SFC impact in cases where the exchanger is not necessary.

So-called surface exchangers also exist, the interest of which is that they cause less disruption in the aerodynamic flow. In the latter, an air flow is brought onto an exchange surface secured to the oil circuit. The exchanger may assume the form of a plate having fins on one side passed through by the air flow and, on another side, oil channels. These surface exchangers are intrinsically lighter and less intrusive, but they are not provided with regulation means, unlike brick-type exchangers. Furthermore, although they are less intrusive, their integration into the turbomachine nevertheless poses the following problems:
increased susceptibility to impacts and more particularly FOD (foreign object damage) if they are positioned in a zone exposed to the flow or centrifugation by the fan;
limited heat exchange when the airplane is stopped if external zones are used;
disruption of the flow, less than that of bricks but constant, with SFC impact (potential interaction with other elements in the flow such as the OGVs (Outlet Guide Vanes), and acoustic (potential interaction with the pulses of the fan).

In the state of the art, EP 2 075 194 A1 is known, which presents a surface air-cooled oil cooler where the oil circuit is positioned inside the separator nose (i.e. the nose separating the air flows coming from the fan in a dual-flow turbomachine) and where the fins are positioned outside the upper wall of the separator nose. The positioning of the exchanger in the separator nose allows to deice the separator nose in addition to cooling the oil.

This surface exchanger also has the drawback that it is provided with no means for regulating the cooling airflow as a function of the usage conditions of the airplane (flight or ground).

As noted in application EP 2 075 194 A1, air-cooled oil coolers offer a heat source that could advantageously be used to deice stagnation points of the air flow, in particular that of the nacelle. Currently, the stagnation points (nacelle and separator nose) are deiced pneumatically by air bleed at the engine or electrically, which requires mechanical sampling causing losses of propulsive output in each case. Furthermore, the increasing use of organic composite materials to replace metal materials requires controlling the temperature inside the structures.

### AIMS OF THE INVENTION

The present invention aims to provide a surface heat-exchanger provided with regulating means allowing to supply an airflow adapted to cooling needs.

The present invention also aims to supply a heat-exchanger whose integration within the turbomachine does not raise the aforementioned problems.

The present invention also aims to produce a heat-exchanger ensuring the deicing of the stagnation points of the air flow.

### MAIN CHARACTERISTICS OF THE INVENTION

The present invention relates to a surface air-cooled oil cooler in an airplane engine comprising at least a first oil circuit and at least a first and second exchange surfaces positioned on either side of the first oil circuit and each able to be swept by an air flow, said second exchange surface being positioned in a cavity provided with an air inlet and an air outlet, said inlet and/or said outlet comprising covering means that allow to regulate the air supply on the second exchange surface.

According to specific embodiments of the invention, the surface air-cooled oil cooler comprises one or a suitable combination of the following features:
the covering means can assume intermediate positions between a completely closed position and a completely open position, said means being configured to be completely closed when the drag of the airplane should be limited or when required by deicing conditions, and to be open when the heat exchange should be increased;
the covering means are configured to be completely closed when the airplane is in cruising mode or in the ground start phase if necessary, to be opened in the intermediate position when the airplane is in the takeoff phase, and to be completely open when the airplane is in ground idle mode;
the covering means are selected from a group consisting of a translation system and of a rotation system;
the first exchange surface does not comprise fins or is provided with fins whose size is dimensioned to reduce the impact on aerodynamic performance, and the second exchange surface is provided with fins; the fins of the first and second surfaces being dimensioned to minimize weighting the criteria for the specific fuel consumption, to minimize their mass, and to optimize their heat performance;
a second oil circuit is positioned in the cavity below the fins of the second exchange surface or is positioned between the first oil circuit and the second exchange surface;
a ring surrounds the fins of the first and/or second surface to increase the exchange surface;
a blower is positioned in the cavity near the air outlet;
the blower is integrated into the fins of the second surface or fastened downstream of said fins;
the ring surrounding the fins of the first surface of the exchanger or the fins of the first surface benefit from a sound treatment so as to absorb the entire or part of the sound spectrum generated by the engine;
it is provided with means ensuring deicing near the location where it is positioned; said means being configured so that the heat transfer occurs either through direct contact with the oil of the surface exchanger, or through natural convection, or through conduction via a thermal bridge or even through a secondary circuit via a diphasic loop;
said exchanger is positioned in the inner or outer portion of a nacelle of the airplane, the second exchange surface being positioned in the cavity of the nacelle;
said exchanger is positioned upstream or downstream of a fan of the airplane engine in the inner portion of the nacelle;
the covering means are configured so as to be actuated by an electric, electrohydraulic, hydraulic, or pneumatic system, or by a passive system activated by the oil temperature.

The present invention also relates to an airplane engine comprising an air-cooled oil cooler as described above.

### BRIEF DESCRIPTION OF THE DRAWINGS

FIG. 1 shows in 1), 2) and 3), respectively, an axial cross-sectional view of an ACOC surface exchanger as in a first embodiment of the invention in different usage phases of the airplane. In 1), the airplane is in ground start mode or cruising mode. In 2), the airplane is in MTO (max takeoff) mode, and in 3), the airplane is in ground idle mode. In 3), cross-sections along axes A-A and B-B are also shown. In 1), 2) and 3), a blower is integrated into the fins of the inner surface of the exchanger. At the bottom of the figure, two other configurations are shown where the blower is fastened at the output of the ACOC.

FIG. 2 shows two axial cross-sectional views of the surface exchanger as in a second embodiment of the invention. Only two usage positions are shown from top to bottom, the ground idle mode and the ground start or cruising mode, respectively.

### KEY

(1) Surface air-cooled oil cooler
(2) First exchange surface or outer surface
(3) Second exchange surface or inner surface
(4) First oil circuit
(5) Second oil circuit
(6) Air inlet into the cavity
(7) Air outlet out of the cavity
(8) Covering means
(9) Cavity
(10) Conduit
(11) Blower
(12) Spring
(13) Control chamber of first covering means
(14) Control chamber of second covering means

### GENERAL DESCRIPTION OF THE INVENTION

The present invention consists in integrating a surface air-cooled liquid cooler into an airplane and, preferably, into the propulsion system (engine+nacelle). According to the invention, the surface exchanger is at least provided with two heat-exchange surfaces, one or both surfaces being swept by the cooling air, depending on the usage phases of the airplane on the ground or during flight. One of the two surfaces, which will be called first surface or outer surface, is exposed to an outside air flow independently of the usage phases of the airplane due to its positioning within the turbomachine, while the second surface is positioned in a cavity and is only exposed to an air flow in certain usage phases of the airplane. In this way, the air flow sweeping the second surface can be modulated owing to means for covering an air inlet and/or outlet of the cavity allowing a greater or lesser air passage, or no air passage at all, toward the inner surface. Preferably, the first surface is dimensioned for the usage phases of the airplane during flight (typically in cases beyond ground idle), while the second surface is only swept by the air and dimensioned to provide the additional cooling that is required during usage phases of the airplane on the ground. In general, the covering means are open when the heat exchange should be increased (in particular when the airspeed is low and, more particularly, at a low rating), while the covering means are closed when the airspeed is sufficient (in particular in cruising mode), the covering means being closed to limit the drag of the airplane.

The second exchange surface is provided with fins and the first exchange surface is provided with fins of reduced dimensions so as not to influence the aerodynamic performance. The latter can even be provided with no fins if the heat-exchange surface is large enough. According to the invention, the orientation angle and the technology of the fins are calculated in order to minimize weighting the SFC criteria and the mass is expressly chosen for each surface, as well as in order to optimize thermal performance.

The means for covering the air inlet and/or outlet can, for example, be a translation or rotation system. To generate a greater flow on the inner surface during low-speed phases, the exchanger may also be provided with a blower.

Still according to the invention, the heat coming from the exchanger is used to deice the nacelle or, more generally, the part of the airplane situated near the exchanger. In the case of nacelles made of a composite material, the deicing system is moreover provided with regulation means.

### DETAILED DESCRIPTION OF THE INVENTION

The surface exchanger as in the invention is illustrated below for embodiments where the exchanger comprises two oil circuits. The present invention also extends to other embodiments where the exchanger comprises only one oil circuit.

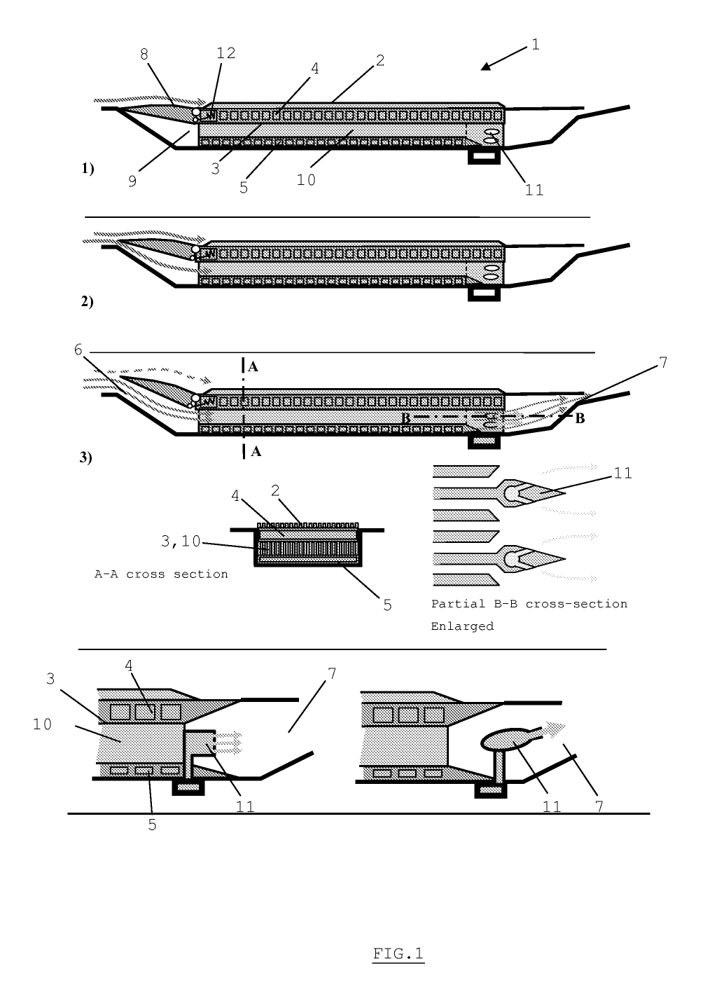

FIG. 1 illustrates a dual-path surface air-cooled oil cooler as in a first embodiment of the invention where the covering means open according to a rotational motion.

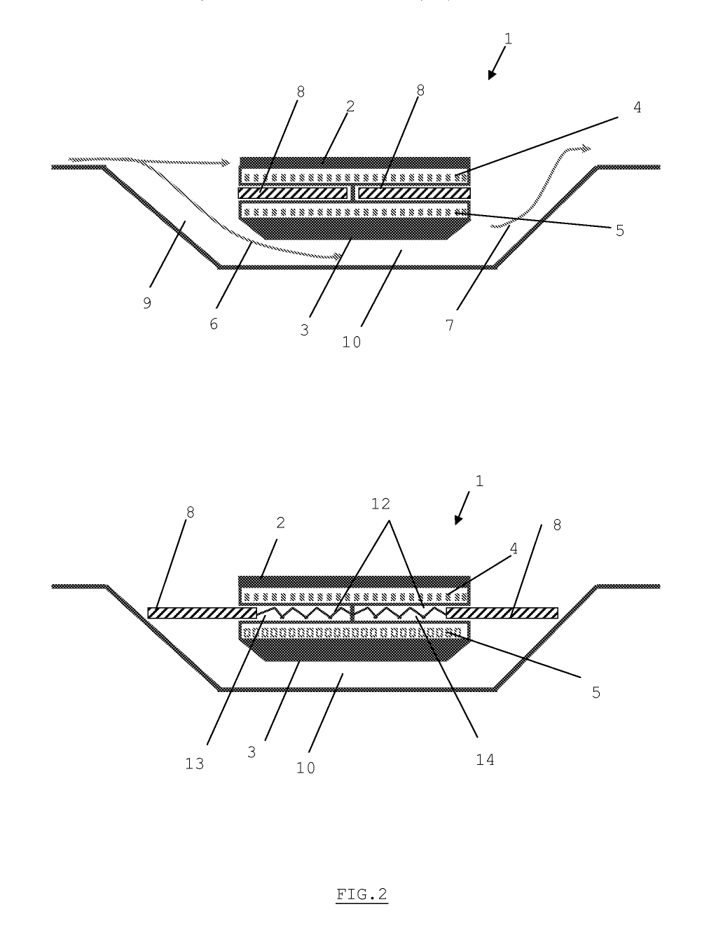

The exchanger 1 comprises a first 2 and a second exchange surfaces provided with fins. It also comprises a first 4 and a second 5 oil circuits and is provided with an air inlet 6 and outlet 7. The inlet 6 comprises covering means 8 such as a duct. The second exchange surface 3 and the second oil circuit 5 are positioned inside a cavity 9, while the first surface 2 is located outside the cavity 9. In the illustrated example, the duct opens toward the outside of the cavity and then forms a duct favoring the air inlet under its inner surface. Alternatively (not shown), the duct can open toward the inside of the cavity so as to keep a good air flow on the outer surface and minimize the aerodynamic impact thereof. As will be described below and illustrated in FIG. 2, the duct can also open in translation to maintain a good air flow on the first surface and minimize the opening and closing force. In all scenarios, the duct is profiled to minimize its impact on the surface flow and balance it as much as possible. Generally, the covering means must be configured to limit the force required to open and close them by limiting the aerodynamic force applied on said covering means.

In the example illustrated in FIG. 1, the covering means cover the air inlet; the present invention also extends to embodiments where the covering means cover the air outlet and to embodiments where the covering means cover both the air inlet and outlet.

The covering means can assume intermediate positions (see view 2)) between a completely closed position (see view 1)) and a completely open position (see view 3)). In this way, when the airplane is on the ground in the start phase, the duct is either closed or open depending on the heat generation and on deicing needs. In 1), the scenario where the duct is closed during the ground start phase of the airplane is illustrated. The duct is also closed when the airplane is in cruising mode; the heat dissipation is then high because a large cold airflow sweeps the first surface. In 2), the airplane is in the MTO phase (max takeoff mode). In this usage phase of the airplane, the heat generation is significant and the cold air flow sweeping the first surface may not be enough to ensure sufficient dissipation. As a result, the duct is slightly or moderately open. In 3), the airplane is in ground idle mode. In that case, the natural heat exchange is limited because the cold airflow is very weak. Consequently, the duct is wide open and the blower is active to generate the flow. In the example illustrated in FIG. 1 in 1), 2) and 3), the blower is integrated into the fins of the second exchange surface (see cross-section B-B) at the outlet of the air flow. As shown at the bottom of FIG. 1, the blower may also be attached at the output of the fins of the second exchange surface.

According to the invention, the covering means may be actuated by an independent system such as an electric, electro-hydraulic, hydraulic or pneumatic system. The actuating system may be shared with other actuating systems not used at the same time (e.g. in the nacelle: reverse, etc.). Alternatively and as illustrated in FIG. 1, they can also be actuated by spring 12 or by a passive system activated by the oil temperature and positioned in the exchanger as a shape-memory material.

The second oil circuit 5 delimits a conduit 10 that channels the air flow created by the duct, optionally assisted by the blower 11. Alternatively (not shown), the exchanger may be provided without a second oil circuit with the result that the conduit for channeling the air flow is embodied by the exchanger on the one hand and by one wall of the cavity (for example of the nacelle) on the other hand. Still alternatively, the exchanger may be provided without a second oil circuit and may be provided with a ring positioned around the fins of the second surface in order to form a conduit and increase the exchange surface. According to the invention, a ring may also be positioned around the fins of the first surface with the same aim of increasing the exchange surface. The fins of the first surface or the ring surrounding the fins of the first surface can also benefit from a sound treatment in order to absorb the entire or part of the sound spectrum generated by the engine.

FIG. 2 is a non-limiting illustration of a second embodiment of the invention where the covering means open in translation. In the illustrated example, the air inlet and outlet are provided with covering means; the present invention of course extends to alternative embodiments where only the inlet or outlet is provided with covering means. Likewise, the exchanger as in this second embodiment may have characteristics similar to those described in the first embodiment, i.e. presence of a ring, sound treatment of the ring surrounding the fins of the first surface or fins of the first surface, presence of a blower near the air outlet (not shown), etc.

Ducts or covering means 8 are integrated between a first oil circuit 4 having a first exchange surface or outer surface 2 and a second oil circuit 5 having a second exchange surface or inner surface 3. Each duct is made up of a shroud or of shroud segments (generally, the duct fits the profile of the exchanger). This embodiment allows to integrate the actuating system of the ducts in the thermal exchanger on the operating principle of a piston. When the inlet and outlet ducts must close the cavity 9 as shown at the bottom of FIG. 2, a control fluid (air or oil) is sent into chambers 13 and/or 14. When the cavity 9 must be open as shown at the top of FIG. 2, a spring 12 can for example allow for the ducts to return within the exchanger body. According to this embodiment, the covering means are also able to assume intermediate positions between a completely closed position and a completely open position.

As already mentioned, the inner surface of the surface exchanger as in the different embodiments of the invention must be positioned opposite a cavity or a conduit in the extension of the air-inlet cavity that may be passed through by an air flow when the air inlet and outlet of the cavity is not obstructed. For example, the exchanger as in the invention can be positioned at the level of the nacelle of the airplane. It may be positioned on the outer wall of the nacelle, i.e. the wall that is not opposite the fan. The first surface being positioned outside the cavity while the second surface is positioned inside the cavity of the nacelle. The exchanger can also be positioned on the inner wall of the nacelle upstream or downstream of the fan (the air flowing from upstream to downstream) and, more specifically, in the secondary stream in the latter case. It may also be positioned in the secondary flow on the outside of the separator separating the primary flow from the secondary flow of the engine. The configuration where the exchanger is positioned on the inner wall of the nacelle downstream of the fan has the advantage that the first surface is protected from FODs, is swept by an airflow of the fan as of start-up of the engine without the airplane being in motion, and does not constitute a burn risk for careless passengers.

Still according to the invention, the exchanger can be positioned continuously on the inner or outer wall of the nacelle or on the outside of the separator then forming a ring, or can be positioned in the form of a non-annular plate.

According to the invention and as already mentioned, the air-cooled oil cooler can be used to deice a surface that is subject to ice accretion. The heat can be transferred by direct contact (for example, by contact with the oil or even via a bleed forming a thermal bridge) if the surface of the exchanger is in contact with the surface to be deiced. The heat can also be transferred by natural convection, since the fins of the inner surface represent a heat-transfer source in the cavity when the latter is covered, and therefore allow to deice the surfaces in the immediate environment. Deicing can also be achieved by conduction via a thermal bridge, for example made via a metal blade. Lastly, deicing can also be achieved via a secondary circuit, for example of the diphasic-loop type.

### ADVANTAGES OF THE INVENTION

The heat-exchanger as in the invention allows to regulate cooling of the oil while preserving the benefits related to the surface exchanger. In this way, the aerodynamic and acoustic impact of the exchanger is minimized as a result of the use of the surface technology, of the dimensioning of the outer surface for the “flight” cases with smaller fins, or even without fins, and of the closing of the inner portion for “flight” cases.

Owing to the use of the exchanger's thermal energy for deicing, it is no longer necessary to take energy from the engine, resulting in output gains.

What is claimed is:

1. A surface air-cooled oil cooler (1) in an airplane engine comprising at least one first oil circuit (4) and at least a first (2) and a second (3) exchange surface positioned on either side of the first oil circuit (4) and each able to be swept by an air flow, said second exchange surface (3) being positioned in a cavity (9) provided with an air inlet (6) and an air outlet (7), said inlet (6) and/or said outlet (7) comprising covering means (8) that allow to regulate the air supply on the second exchange surface (3).

2. The surface exchanger (1) as in claim 1, wherein the covering means (8) can assume intermediate positions between a completely closed position and a completely open position, said means being configured to be completely closed when the drag of the airplane should be limited, and to be open when the heat exchange should be increased.

3. The surface exchanger (1) as in claim 1, wherein the covering means (8) are configured to be completely closed when the airplane is in cruising mode or in the ground start phase, to be opened in the intermediate position when the airplane is in the takeoff phase, and to be completely open when the airplane is in ground idle mode.

4. The surface exchanger (1) as in claim 1, wherein the covering means (8) are selected from the group consisting of a translation system and of a rotation system.

5. The surface exchanger (1) as in claim 1, wherein the first exchange surface (2) does not comprise fins or is provided with fins whose size is dimensioned to reduce the impact on aerodynamic performance, and wherein the second exchange surface (3) is provided with fins; the fins of the first (2) and of the second (3) surfaces being dimensioned to minimize weighting of the criteria for the specific fuel consumption, minimize their mass, and optimize their heat performance.

6. The surface exchanger (1) as in claim 5, wherein a second oil circuit (5) is positioned in the cavity (9) below the fins of the second exchange surface (3) or is positioned between the first oil circuit (4) and the second exchange surface (3).

7. The surface exchanger (1) as in claim 5, wherein a ring surrounds the fins of the first (2) and/or of the second (3) surface to increase the exchange surface.

8. The surface exchanger (1) as in claim 1, wherein a blower (11) is positioned in the cavity (9) near the air outlet (7).

9. The surface exchanger (1) as in claim 8, wherein the blower (11) is integrated to the fins of the second surface (3) or fastened downstream of said fins.

10. The surface exchanger (1) as in claim 5, wherein the ring surrounding the fins of the first surface (2) of the exchanger or the fins of the first surface (2) benefit from a sound treatment in order to absorb the entire or part of the sound spectrum generated by the engine.

11. The surface exchanger (1) as in claim 1, which is provided with means ensuring the deicing near the location where it is positioned; said means being configured so that heat transfer is selected from the group consisting of through direct contact with the oil of the surface exchanger (1), through natural convection, through conduction via a thermal bridge, and through a secondary circuit via a diphasic loop.

12. The surface exchanger (1) as in claim 1, wherein said exchanger (1) is positioned in the inner or outer wall of a nacelle of the airplane, the second exchange surface (3) being positioned in the cavity (9) of the nacelle.

13. The surface exchanger (1) as in claim 12, wherein said exchanger (1) is positioned upstream or downstream of the fan of the airplane engine in the inner portion of the nacelle.

14. The surface exchanger (1) as in claim 1, wherein the covering means (8) are configured to be actuated by a system selected from the group consisting of an electric system, electrohydraulic system, hydraulic system, pneumatic system, and by a passive system activated by the oil temperature.

15. An airplane engine comprising an air-cooled oil cooler (1) as in claim 1.
